(19) United States
(12) Patent Application Publication
(10) Pub. No.: US 2011/0031852 A1
(43) Pub. Date: Feb. 10, 2011

(54) Labels for canned nuts

(76) Inventor: Cheryl J. Singleton, Mineola, TX (US)

Correspondence Address: LITMAN LAW OFFICES, LTD., PATENT LAW BUILDING, 8955 CENTER STREET, MANASSAS, VA, 20110, US

(21) Appl. No.: 12/461,269

(22) Filed: Aug. 5, 2009

(51) Int. Cl. G09F 3/00; G09F 3/10; A47F 3/00

(52) U.S. Cl. 312/118; 40/306

(57) ABSTRACT

The labels for canned nuts include a preprinted wrapper label dimensioned to exactly fit around a conventional standard size can of nuts. Short witty sayings such as “Go NUTS—it's your birthday” or “I'm just NUTS about you” are inscribed on the label along with cartoon-type characters and nutritional information concerning the ingredients of the nuts. Also included is a greeting-card type top label, which top label is configured to fit the circular lid of the can. The top label is designed to open up similar to a greeting card and may optionally be provided with pop-ups and/or musical recordings. The rear surfaces of the wrapper label and top label are coated with an adhesive to enhance attachment to the can. A replica of a house, to be dubbed “The Nut House”, is contemplated for displaying the labels and toppers.

### BACKGROUND OF THE INVENTION

1. Field of the Invention

The present invention generally relates to message or greeting devices, and more specifically to personal gift labels for canned nuts.

2. Description of the Related Art

In the art of gifting, the personalized gift, no matter the cost, is often more treasured than a more expensive impersonal gift. The recipient is always appreciative if it is believed that the giver invested thought and effort in choosing a gift. In many instances, token gifts or small favors are the gifts of choice. Often such gifts involve packaged treats or snacks such as a can of nuts. It would certainly add zest to a party or similar affair if a normally mundane can of nuts could be personalized in a manner to produce a sense of levity and enliven conversation. Thus, providing unique labels for canned nuts solving the aforementioned problems is desired.

### SUMMARY OF THE INVENTION

The labels for canned nuts include a pre-printed wrapper label dimensioned to exactly fit around a conventional, standard size can of nuts. Short witty sayings such as “Go NUTS—it's your birthday” or “I'm just NUTS about you” are inscribed on the label, along with cartoon-type characters. Also included is a greeting-card-type top label. The top label is configured to fit the circular lid (usually plastic) of the can. The top label is designed to open up similar to a greeting card, and may optionally be provided with pop-ups and/or musical recordings. A separate label is provided that is attached to the bottom of the can. This label will have ingredients and nutritional information inscribed thereon relative to the particular variety of nuts contained in the can. The rear surfaces of the wrapper label, top label and bottom label are coated with an adhesive to enhance attachment to the surfaces of the can. A replica of a house, which may be called “The Nut House”, is contemplated for displaying the various labels.

Accordingly, the invention presents personalized labels for adorning standard-sized cans of nuts. The labels include a wrapper for disposition around the circumference of the can, a top label for disposition on the lid of the can and a bottom label for attachment to the bottom of the can. The labels may be utilized separately or together as desired. As presently contemplated, each individual greeting label will be packaged with a complete set of nutritional labels. The wrapper label and top label are inscribed with witty sayings and cartoon characters pertaining to nuts, and the giver can sign both if desired. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of labels for canned nuts according to the present invention.

FIG. 2 is a top view of labels for canned nuts according to the present invention.

FIG. 3 is a front view of a wrapper label for canned nuts according to the present invention.

FIG. 4 is an environmental, perspective view of a display house for labels for canned nuts according to the present invention.

Similar reference characters denote corresponding features consistently throughout the attached drawings.

### DETAILED DESCRIPTION OF THE PREFERRED EMBODIMENTS

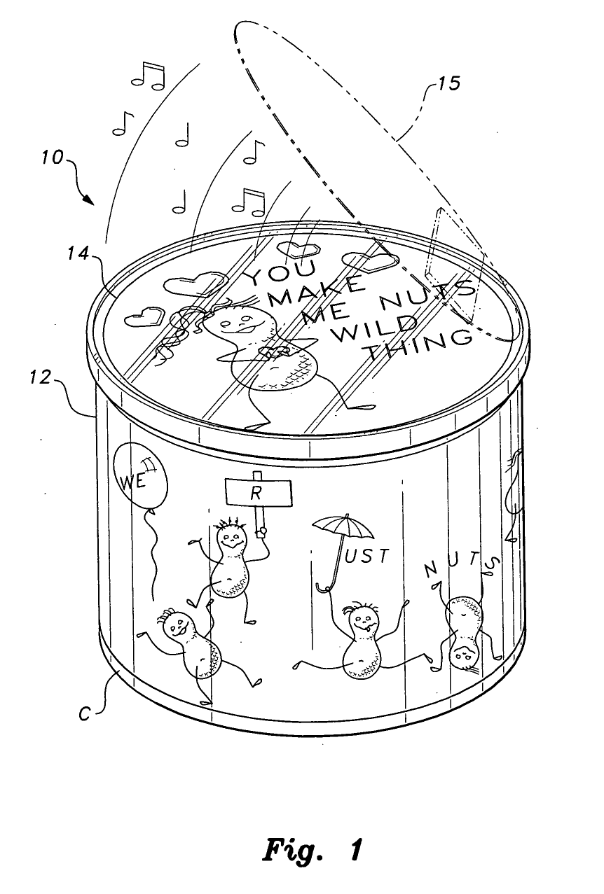

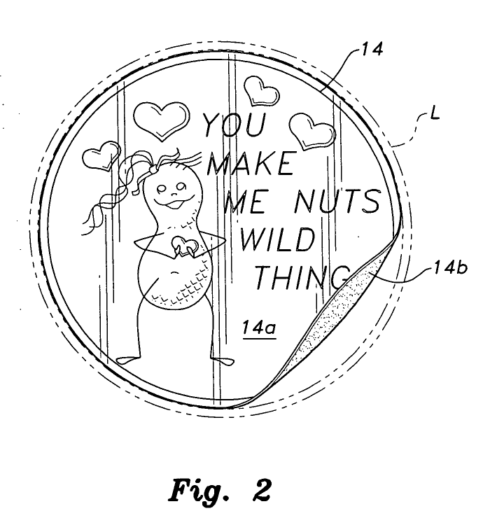

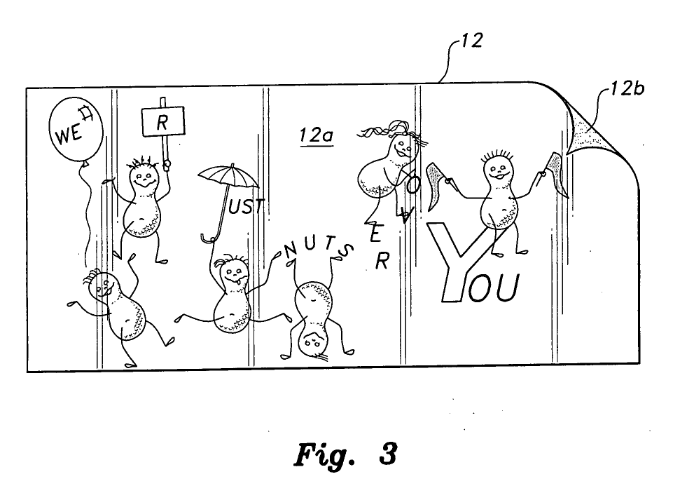

Referring to FIGS. 1-3, the labels for canned nuts are generally indicated at 10. Labels 10 include a wrapper label 12 and a top label 14. Wrapper label 12 is dimensioned to be coextensive with the circumference of a conventional, standard size can C, which can houses a supply of nuts therein. Wrapper label 12 is of a rectangular configuration and has a front surface 12a and rear surface 12b. Front surface 12a is inscribed with a witty saying(s) and cartoon caricatures pertinent to nuts. Rear surface 12b is provided with an adhesive thereon so that the wrapper can quickly and easily be attached to can C. A conventional release liner (not shown) is provided to overlie the adhesive until ready for use.

Top label 14 is of a circular configuration and has a diameter that is slightly less than the diameter of a standard size lid L of a conventional nut can. Top label 14 can be designed to unfold similar to a greeting card to reveal a nut-related witty saying. Top label 14 can also be provided with a pop-up feature and pre-recorded message or song 15 as is commonly featured in greeting cards. The upper surface 14a of top label 14 is inscribed with witty sayings and cartoon caricatures pertaining to nuts. The undersurface 14b of top label 14 is coated with an adhesive so that the top label may be easily affixed to the lid L. As noted above, bottom labels, which are the generally sized substantially the same as the top labels, may be affixed to the bottoms of the can.

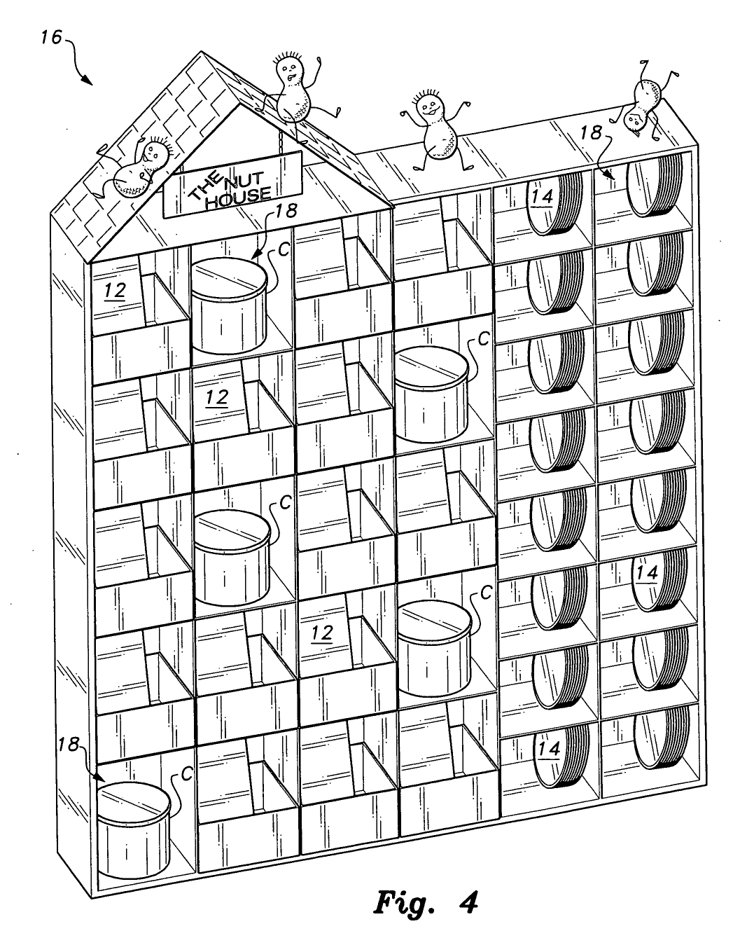

As best seen in FIG. 4, a unique structure 16 is provided to display the labels 12 and 14 (including the bottom labels). Structure 16 is similar to the cut-away back of a dollhouse having separate rooms 18 exposed. Each room 18 will contain either a like plurality of wrapper labels 12, a like plurality of top (and bottom) labels 14 or a can of nuts (variety may differ). This arrangement allows the purchaser to browse the variety of sayings and select the one best suited for the upcoming occasion and to choose an appropriate bottom label relative to the selected can of nuts. As noted above the display structure may be called “The Nut House”.

It is to be understood that the present invention is not limited to the embodiments described above, but encompasses any and all embodiments within the scope of the following claims.

I claim:

1. Labels for canned nuts, comprising:
a wrapper label having a front surface and a rear surface, the wrapper label being adapted for attachment to an outer circumferential surface of a can of nuts;
indicia disposed on the front surface of the wrapper label, the indicia including witty sayings and cartoon caricatures;
a top label having an upper surface and a lower surface, the top label being adapted for attachment to an outer surface of a lid of the can of nuts;
indicia disposed on the upper surface of the top label, the indicia including witty sayings and cartoon caricatures; and
adhesive disposed on the rear surface of the wrapper label and the lower surface of the top label.

2. The labels for canned nuts according to claim 1, wherein the witty sayings and cartoon caricatures disposed on the front surface of said wrapper label and on the upper surface of said top label pertain to nuts.

3. The labels for canned nuts according to claim 1, wherein said wrapper label is rectangular.

4. The labels for canned nuts according to claim 1, wherein said top label is circular.

5. The labels for canned nuts according to claim 1, wherein said top label includes a pop-up feature.

6. Labels for canned nuts, comprising:
a wrapper label of rectangular configuration, the wrapper label having a front surface and a rear surface, the wrapper label being adapted for attachment to an outer circumferential surface of a can of nuts;
indicia disposed on the front surface of the wrapper label, the indicia including witty sayings and cartoon caricatures pertaining to nuts;
a top label of circular configuration, the top label having an upper surface and a lower surface, the top label being adapted for attachment to an outer surface of a lid of the can of nuts;
indicia disposed on the upper surface of the top label, the indicia including witty sayings and cartoon caricatures pertaining to nuts; and
adhesive disposed on the rear surface of the wrapper label and the lower surface of the top label.

7. The labels for canned nuts according to claim 6, wherein said top label includes a pop-up feature.

8. A label kit for canned nuts, the kit comprising:
a display structure simulating a dollhouse structure having a cut-away back;
a plurality of miniature rooms disposed in the display structure;
a plurality of humorous, decorative wrapper labels disposed in a first portion of the plurality of miniature rooms;
a plurality of top labels disposed in a second portion of the plurality of miniature rooms; and
a plurality of cans of nuts disposed in a third portion of the plurality of miniature rooms, the wrapper labels being adapted for attachment to a front surface and the top labels being adapted for attachment to a lid of the can of nuts;
wherein the cans of nuts may be selectively decorated as a gift item by customized selection of one of the wrapper labels and one of the top labels.

9. The label kit for canned nuts according to claim 8, wherein each said wrapper label is rectangular, having a front surface and a rear surface, indicia being disposed on each of the front surfaces, the indicia including witty sayings and cartoon caricatures pertaining to nuts;

10. The label kit for canned nuts according to claim 8, wherein each said top label is circular, having an upper surface and a lower surface, indicia being disposed on each of the upper surfaces the indicia including witty sayings and cartoon caricatures pertaining to nuts.

11. The label kit for canned nuts according to claim 10, wherein said top labels define popups.

12. The label kit for canned nuts according to claim 10, wherein said top labels have a portion of a musical recording embedded therein, the musical recording being played back when the top label is opened; and
circular bottom labels for attachment to a bottom of the can, wherein said bottom labels are inscribed with nutritional information relative to nuts contained in the can.
